(19) United States
(12) Patent Application Publication
(10) Pub. No.: US 2018/0336609 A1
(43) Pub. Date: Nov. 22, 2018

(54) SERVICE PROCESSING METHOD AND APPARATUS

(71) Applicant: Tencent Technology (Shenzhen) Company Limited, Shenzhen (CN)

(72) Inventor: Xueying Ji, Shenzhen (CN)

(21) Appl. No.: 15/985,377

(22) Filed: May 21, 2018

Related U.S. Application Data
(63) Continuation-in-part of application No. PCT/CN2017/072235, filed on Jan. 23, 2017.

(30) Foreign Application Priority Data
Feb. 5, 2016 (CN) 201610081857.X

(51) Int. Cl. G06Q 30/06; G06Q 30/02; G06Q 30/00; G06F 3/0482

(52) U.S. Cl. CPC G06Q 30/0611; G06Q 30/0641; G06F 3/0482; G06Q 30/01; G06Q 30/0281

(57) ABSTRACT

The present disclosure discloses a service processing method performed at a first terminal. The first terminal displays an initiating option user interface for a value collection service of a target object, the value collection service being used by a second user other than a first user to provide a value for a behaviour of the first user for purchasing the target object. After detecting a user response to the initiating option, the first terminal sends, to a server, a request for initiating value collection. The request for initiating value collection carries an identifier of the target object and an identifier of the first user and the relationship type between the first user and the second user and the relationship type between the first user and the second user. The server then generates a value collection message accordingly and sends it to a second terminal associated with the second user.

### RELATED APPLICATION

This application is a continuation-in-part application of PCT/CN2017/072235, entitled “SERVICE PROCESSING METHOD AND DEVICE” filed on Jan. 23, 2017, which claims priority to Chinese Patent Application No. 201610081857.X, filed with the State Intellectual Property Office of the People's Republic of China on Feb. 5, 2016, and entitled “SERVICE PROCESSING METHOD AND DEVICE”, all of which are incorporated herein by reference in their entirety.

### FIELD OF THE TECHNOLOGY

The present disclosure relates to the field of Internet technologies, and in particular, to a service processing method and apparatus.

### BACKGROUND OF THE DISCLOSURE

With development of Internet technologies, there are a growing number of services that can be performed by using the Internet, for example, a purchase service, a payment service, and a communications service. In the purchase service, a user can purchase a commodity on a purchase page provided by a merchant according to a price set by the merchant, so as to obtain the commodity the user wants.

### SUMMARY

To resolve problems in the existing technology, embodiments of the present disclosure provide a service processing method and apparatus. The technical solutions are as follows:

According to a first aspect, a service processing method is performed at a first terminal having one or more processors and memory storing instructions to be executed by the one or more processors. The method includes:

displaying an initiating option user interface for a value collection service of a target object, the value collection service being used by a second user other than a first user to provide a value for a behaviour of the first user for purchasing the target object; detecting, from the first user, a user response to the initiating option, the user response including a relationship type between the first user and the second user; and sending, to a server, a request for initiating value collection, the request for initiating value collection carrying an identifier of the target object and an identifier of the first user and the relationship type between the first user and the second user and the relationship type between the first user and the second user, wherein the server is configured to generate a value collection message accordingly and sends the value collection message to a second terminal associated with the second user.

According to a second aspect, a first terminal includes one or more processors, memory and a plurality of instructions stored in the memory that, when executed by the one or more processors, cause the first terminal to perform the aforementioned method.

According to a third aspect, a non-transitory computer readable medium stores at least one program configured for execution by a first terminal having one or more processors, the at least one program comprising instructions for performing the aforementioned method.

Beneficial effects brought by the technical solutions provided in the embodiments of the present disclosure are as follows:

The value collection message initiated by the first user is sent to the client in which the user on the relationship chain of the first user is located, that is, the client in which the second user is located, so that the second user can respond to the value collection service initiated by the first user. In addition, the transferred value of the second user is converted by using the value conversion policy, and the value collection service initiated by the first user is responded to by using the converted transferred value. That is, when a sponsor service is performed, a sponsor page initiated by the first user is sent to the client in which the user on the relationship chain of the first user is located, that is, the client in which the second user is located, so that the second user can respond to the sponsor service initiated by the first user. In addition, a transferred value that the second user wants to provide is converted by using the value conversion policy, and the sponsor service initiated by the first user is responded to by using the converted transferred value. Therefore, on one hand, because the user on the relationship chain of the first user, that is, the second user, has a personal relationship with the first user, the probability that the second user sponsors the sponsor service initiated by the first user is relatively large, thereby improving the efficiency of the sponsor service, and ensuring that the sponsor service can obtain sufficient money. Therefore, adhesion of the user is increased. On the other hand, because a converted transferred value obtained by converting the transferred value that the second user wants to provide by using the value conversion policy is always greater than the transferred value that the second user wants to provide, so that the second user can sponsor the sponsor service of the first user with a relatively large value by using a relatively small transferred value. This can increase an inner driving force for enabling the second user to sponsor, so that the probability that the second user sponsors the sponsor service initiated by the first user is increased, thereby improving the efficiency of the sponsor service, and ensuring that the sponsor service can obtain sufficient money. Therefore, the adhesion of the user is increased.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a service processing system according to an exemplary embodiment;

FIG. 2 is a flowchart of a service processing method according to an exemplary embodiment;

FIG. 3 is a flowchart of a service processing method according to an exemplary embodiment;

FIG. 4 is a flowchart of a service processing method according to an exemplary embodiment;

FIG. 5 is a flowchart of a service processing method according to an exemplary embodiment;

FIG. 6 is a schematic diagram of a target object description interface of value collection according to an exemplary embodiment;

FIG. 7 is a schematic diagram of a value collection message according to an exemplary embodiment;

FIG. 8 is a schematic diagram of an interface for confirming value collection according to an exemplary embodiment;

FIG. 9 is a schematic diagram of an interface of a token for initiating value collection according to an exemplary embodiment;

FIG. 10 is a schematic diagram of a value collection status interface according to an exemplary embodiment;

FIG. 11 is a schematic diagram of displaying a user who performs value collection according to an exemplary embodiment;

FIG. 12 is a block diagram of a service processing apparatus 1200 according to an exemplary embodiment;

FIG. 13 is a block diagram of a service processing apparatus 1300 according to an exemplary embodiment;

FIG. 14 is a block diagram of a service processing apparatus 1400 according to an exemplary embodiment;

FIG. 15 is a block diagram of a service processing apparatus 1500 according to an exemplary embodiment;

FIG. 16 is a block diagram of a service processing apparatus 1600 according to an exemplary embodiment;

FIG. 17 is a block diagram of a service processing apparatus 1700 according to an exemplary embodiment;

FIG. 18 is a block diagram of a terminal 1800 according to an exemplary embodiment; and

FIG. 19 is a block diagram of a service processing apparatus 1900 according to an exemplary embodiment.

### DESCRIPTION OF EMBODIMENTS

To make the objectives, technical solutions, and advantages of the present disclosure clearer, the following further describes implementations of the present disclosure in detail with reference to the accompanying drawings.

FIG. 1 is a schematic structural diagram of a service processing system according to an exemplary embodiment. The service processing system may include a first terminal 101, at least one second terminal 102, and a server 103. The first terminal 101 is a terminal that initiates a value collection service, and the at least one second terminal 102 is a terminal that responds to the value collection service initiated by the first terminal 101. The first terminal 101 is connected to the server 103 in a wired or wireless communication manner, and the at least one second terminal 102 is connected to the server 103 in a wired or wireless communication manner.

In some embodiments, the value collection service is provided in connection with a social networking platform (e.g., an instant messaging service) hosted by the server 103. For example, a first user logs into his/her account of the instant messaging service at the first terminal 101 and a second user logs into his/her account of the instant messaging service at the second terminal 102. The first and second users can exchange messages with each other after a direct-contact relationship is established between the two user accounts by the server 103. Alternatively, the two user accounts are members of a multi-user chat group hosted by the server 103 such that one user account can share/view messages with/from other user accounts even if there is no direct-contact relationship between the two user accounts. Sometimes, the two user accounts are both subscribers of another user account (e.g., a third-party official account) of the social networking platform such that both user accounts can communicate with the third-party official account without knowing the existence of other user accounts that have subscribed to the third-party official account.

In some embodiments, each user account of the instant messaging service has an associated value representing the digital credit owned by the user account. Such digital credit may be used for purchasing virtual goods and/or services on the Internet or goods and/or services in the real world. Sometimes the server 103 establishes a connection between this user account of the instant messaging service with the user's actual bank account in the real world so that the digital credit can be exchanged between the two accounts. In the present application, terms like “value”, “digital value” and “digital credit” are used interchangeably. Using the instant messaging service, a user can perform many perform many operations related to the exchange of digital credits with another user just like exchanging messages with one another. This is not only a significant extension to the instant messaging service but also an important enhancement of financial technology because the latter can take advantage of the online security system built into the instant messaging service. Moreover, as noted below, there are many flexible ways of exchanging digital credit between any two user accounts of the instant messaging service based on the existing relationship between the two user accounts, e.g., direct-contact, members of a chat group, or subscribers of the same third-party official account.

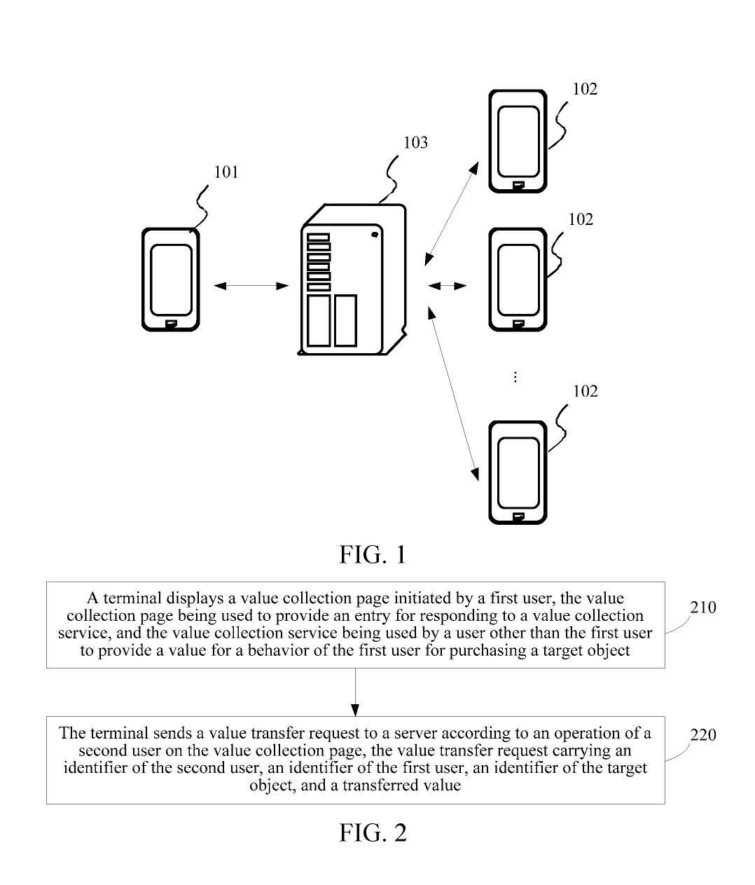

FIG. 2 is a flowchart of a service processing method according to an exemplary embodiment. The service processing method is applied to the second terminal shown in FIG. 1. As shown in FIG. 2, the service processing method includes the following steps:

210: The terminal displays a value collection message initiated by a first user, the value collection message being used to provide an entry for responding to the value collection service, and the value collection service being used by a user other than the first user to provide a value for a behaviour of the first user for purchasing a target object.

220: The terminal sends a value transfer request to the server according to an operation of a second user on the value collection message, the value transfer request carrying an identifier of the second user, an identifier of the first user, an identifier of the target object, and a transferred value, so that the server converts the transferred value according to a value conversion policy and responds, based on a converted transferred value, to the value collection service initiated by the first user.

To sum up, according to the service processing method provided in this embodiment, the value collection message initiated by the first user is displayed, the value transfer request is sent to the server according to the operation of the second user on the value collection message, and the transferred value of the second user is converted according to the value conversion policy, so that the converted transferred value is used to respond to the value collection service initiated by the first user. Because the transferred value obtained by converting the transferred value of the second user by using the value conversion policy is always greater than the original transferred value of the second user, the second user may respond to the value collection service of the first user with a relatively large value by using a relatively small transferred value. When the method is applied to a sponsor service, an inner driving force for enabling the second user to sponsor can be increased, so that the probability that the second user sponsors the sponsor service initiated by the first user is increased, thereby improving the efficiency of the sponsor service, and ensuring that the sponsor service can obtain a sufficient transferred value. Therefore, adhesion of the user is increased.

In a first possible implementation, after the sending a value transfer request to a server, the method further includes:

obtaining a token for initiating value collection, the token for initiating value collection being issued by the server after the responding, based on a converted transferred value, to the value collection service initiated by the first user, and the token for initiating value collection including: a token for forwarding the value collection message initiated by the first user, or at least one of tokens for initiating another value collection service by the tokens themselves.

In a second possible implementation, the value conversion policy includes:

converting the transferred value into a final transferred value, the final transferred value being a preset multiple of the transferred value.

All optional technical solutions above may be combined in any manner to form optional embodiments of the present disclosure. Details are not further described herein one by one.

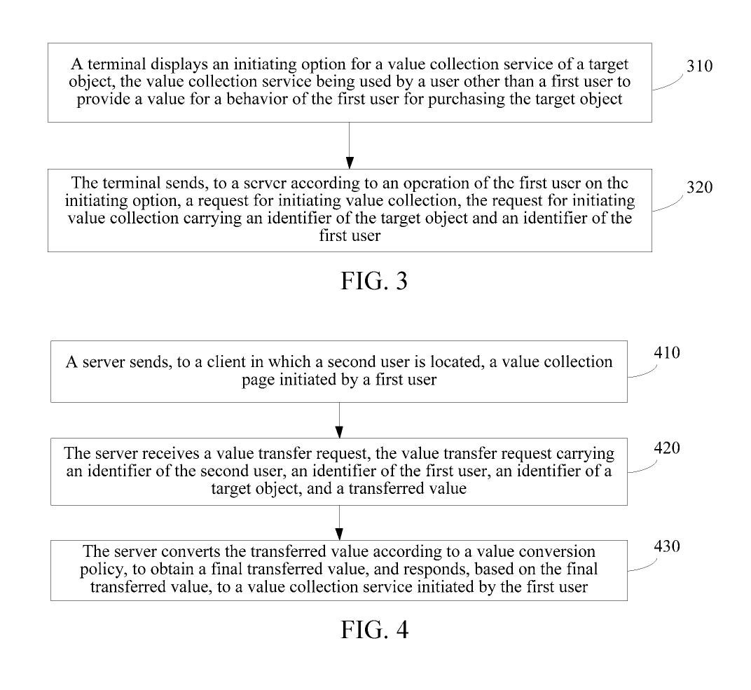

FIG. 3 is a flowchart of a service processing method according to an exemplary embodiment. The service processing method is applied to the first terminal shown in FIG. 1. As shown in FIG. 3, the service processing method includes the following steps:

310: The terminal displays an initiating option user interface for the value collection service of a target object, the value collection service being used by a second user other than a first user to provide a value for a behaviour of the first user for purchasing the target object.

In some embodiments, the initiating option user interface includes an option for the first user to choose the scope of the value collection service when the value collection service is associated with the instant messaging service. For example, the option for choosing the scope of the value collection service includes one or more choices based on the relationship type between the first user and the second user according to the instant messaging service, e.g., direct-contact relationship, members of the same chat group, and subscribers of the same third-party official account, etc.

320: The terminal sends, to the server according to an operation of the first user on the initiating option, a request for initiating value collection, the request for initiating value collection carrying an identifier of the target object and an identifier of the first user and the relationship type between the first user and the second user, so that the server generates a value collection message and sends the value collection message to a second terminal associated with the second user, the value collection message being used to provide an entry for responding to the value collection service, and the at least one target client being a client in which a user on a user relationship chain of the first user is located.

As noted above, the first user can choose one or more of the choices to determine whom the request for value collection service should be sent to. Based to the user-selected relationship type, the server chooses the user accounts of the instant messaging service to send the value collection message to the terminals corresponding to these user accounts. In some embodiments, when the value collection message appears on the application running the instant messaging service at the terminal, it includes an indicator of the relationship type between the first user and the second user, e.g., a direct-contact relationship between them, members of the same chat group, and subscribers of the same third-party official account, etc. Based on the indicator, the second user can determine whether or not to respond to the request and the amount of value to contribute to the first user for the target object. In some embodiments, the value collection message also includes an invitation to the second user for establishing a direct relationship between the first user and the second user. In some other embodiments, in connection with the contribution from the second user, an invitation for establishing a direct relationship between the first user and the second user is sent back to the first terminal associated with the first user. Alternatively, after the server receives the contribution from the second user itself, the server generates a direct relationship between the first user and the second user. This approach is especially useful for enhancing the capability of the instant messaging service when the first user and the second user do not know each other's existence but are only related to each other via a third-party official account of which they are both subscribers.

To sum up, according to the service processing method provided in this embodiment, the request for initiating value collection is sent to the server, so that the server generates the value collection message, and sends the value collection message to the client in which the user on the relationship chain of the first user is located. Therefore, the user on the relationship chain of the first user can respond to the value collection service initiated by the first user. When the method is applied to a sponsor service, because the user on the relationship chain of the first user has a personal relationship with the first user, the probability that the user on the relationship chain of the first user sponsors the sponsor service initiated by the first user is relatively large, thereby increasing the efficiency of the sponsor service, and ensuring that the sponsor service can obtain sufficient money. Therefore, adhesion of the user is increased.

In a first possible implementation, after the sending, to the server, a request for initiating value collection, the service processing method further includes:

receiving a value collection status interface, the value collection status interface being used to indicate a value collection completion status of the target object; and

displaying the value collection status interface.

In a second possible implementation, the value collection status interface further includes an option for viewing a user who responds to the value collection, and after the displaying the value collection status interface, the method further includes:

obtaining an identifier of a user who responds to the value collection service of the target object and a corresponding transferred value, after a triggering operation for the option for viewing a user who responds to the value collection is detected; and displaying the identifier of the user and the corresponding transferred value based on the value collection status interface.

In a third possible implementation, the request for initiating value collection further carries a value collection type identifier, the value collection type identifier is used to enable the server to generate a value collection message corresponding to the value collection type identifier, and different value collection type identifiers correspond to different value conversion policies.

All optional technical solutions above may be combined in any manner to form optional embodiments of the present disclosure. Details are not further described herein one by one.

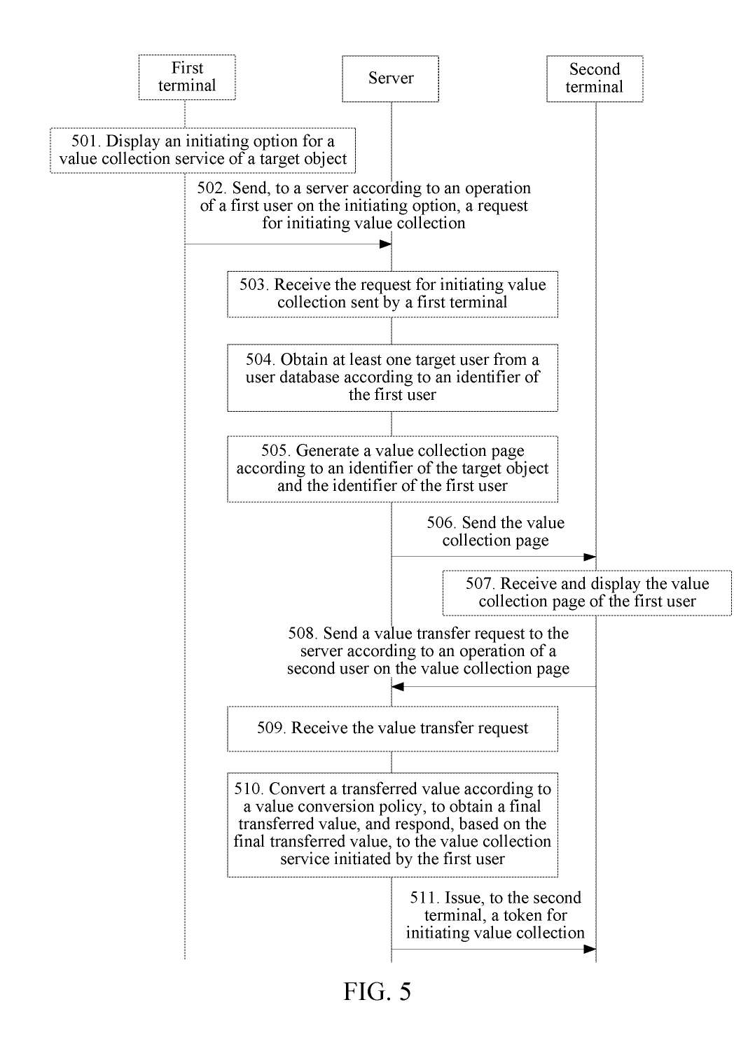

FIG. 4 is a flowchart of a service processing method according to an exemplary embodiment. The service processing method is applied to the server shown in FIG. 1. As shown in FIG. 4, the service processing method includes the following steps:

410: The server sends, to a client in which a second user is located, a value collection message initiated by a first user, so that the client in which the second user is located sends a value transfer request to itself according to an operation of the second user on the value collection message.

420: The server receives the value transfer request, the value transfer request carrying an identifier of the second user, an identifier of the first user, an identifier of a target object, and a transferred value.

430: The server converts the transferred value according to a value conversion policy, to obtain a final transferred value, and responds, based on the final transferred value, to the value collection service initiated by the first user, the value collection service being used by a user other than the first user to provide a value for a behaviour of the first user for purchasing the target object.

To sum up, according to the service processing method provided in this embodiment, the value collection message initiated by the first user is sent to the client in which the second user is located, so that the second user can respond to the value collection service initiated by the first user. In addition, the transferred value of the second user is converted by using the value conversion policy, and the value collection service initiated by the first user is responded to by using the converted transferred value. Therefore, when the method is applied to a sponsor service, on one hand, because the second user has a personal relationship with the first user, the probability that the second user sponsors the sponsor service initiated by the first user is relatively large, thereby improving the efficiency of the sponsor service, and ensuring that the sponsor service can obtain sufficient money. Therefore, adhesion of the user is increased. On the other hand, because a converted transferred value obtained by converting, by using the value conversion policy, a transferred value that the second user wants to provide is always greater than the transferred value that the second user wants to provide, so that the second user can sponsor the sponsor service of the first user with a relatively large value by using a relatively small transferred value. This can increase an inner driving force for enabling the second user to sponsor, so that the probability that the second user sponsors the sponsor service initiated by the first user is increased, thereby improving the efficiency of the sponsor service, and ensuring that the sponsor service can obtain sufficient money. Therefore, the adhesion of the user is increased.

In a first possible implementation, the converting the transferred value according to a value conversion policy, to obtain a final transferred value, and responding, based on the final transferred value, to the value collection service initiated by the first user includes:

receiving a target object purchase request sent by a client in which the first user is located;

obtaining a first difference between a target value and the final transferred value after receiving the target object purchase request, the target value being a value required for purchasing the target object; and subtracting the first difference from an account bond with the first user, and adding the first difference and the transferred value to an account bond with the target object, to complete the behaviour of the first user for purchasing the target object; or subtracting the first difference from an account bond with the first user, subtracting a second difference between the final transferred value and the transferred value from a specified account, and adding the first difference and the final transferred value to an account bond with the target object, to complete the behaviour of the first user for purchasing the target object.

In a second possible implementation, the converting the transferred value according to a value conversion policy, to obtain a final transferred value, and responding, based on the final transferred value, to the value collection service initiated by the first user includes:

returning the transferred value to an account bond with the second user or adding the transferred value to an account bond with the first user if receiving a purchase giving up request sent by a client in which the first user is located.

In a third possible implementation, after the responding, based on the converted transferred value, to the value collection service initiated by the first user, the service processing method further includes:

issuing, to the client in which the second user is located, a token for initiating value collection, the token for initiating value collection including: a token for forwarding the value collection message initiated by the first user, or at least one of tokens for initiating another value collection service by the client in which the second user is located.

In a fourth possible implementation, the value conversion policy includes:

converting the transferred value into a final transferred value, the final transferred value being a preset multiple of the transferred value.

In a fifth possible implementation, before the sending, to a client in which a second user is located, a value collection message of a first user, the service processing method further includes:

receiving a request for initiating value collection sent by a client in which the first user is located, the request for initiating value collection carrying the identifier of the target object and the identifier of the first user;

obtaining at least one target user from a user database according to the identifier of the first user, the at least one target user being a user on a user relationship chain of the first user;

generating the value collection message according to the identifier of the target object and the identifier of the first user, the value collection message being used to provide an entry for performing value collection on the target object; and sending the value collection message to a client in which the at least one target user is located.

In a sixth possible implementation, after the sending the value collection message to a client in which the at least one target user is located, the service processing method further includes:

obtaining a value collection completion status of the target object;

generating a value collection status interface according to the value collection completion status; and

sending the value collection status interface to the client in which the first user is located.

In a seventh possible implementation, after the sending the value collection message to a client in which the at least one target user is located, the service processing method further includes:

obtaining an identifier of a user who responds to the value collection service of the target object and a corresponding transferred value; and

sending the identifier of the user and the corresponding transferred value to the client in which the first user is located.

In an eighth possible implementation, the request for initiating value collection further carries a value collection type identifier, and different value collection type identifiers correspond to different value conversion policies; and the generating the value collection message according to the identifier of the target object and the identifier of the first user includes:

generating the value collection message according to the identifier of the target object, the identifier of the first user, and the value collection type identifier.

All optional technical solutions above may be combined in any manner to form optional embodiments of the present disclosure. Details are not further described herein one by one.

FIG. 5 is a flowchart of a service processing method according to an exemplary embodiment. The service processing method is applied to the service processing system shown in FIG. 1. The service processing method includes the following steps:

501: The first terminal displays an initiating option user interface for the value collection service of a target object, the value collection service being used by a second user other than a first user to provide a value for a behaviour of the first user for purchasing the target object.

The provided value may be a real currency value, a bonus point value, a voucher value, and the like. This is not limited in the present disclosure.

The present disclosure provides a service processing method. The service processing method is particularly applicable to process a service for initiating value collection and a service for responding to the value collection service. In an actual application, the service for initiating value collection and the service for responding to the value collection service are generally represented as a service for initiating sponsoring and a service for sponsoring. Therefore, in the following description of the present disclosure, the service for initiating sponsoring and the service for sponsoring are used as examples for description. Certainly, in an actual application, the service for initiating value collection and the service for responding to the value collection service may alternatively be in other representation forms, but the other representation forms are similar to the service for initiating sponsoring and the service for sponsoring. Details are not further described in the present disclosure. A reader should understand that in the following description of the present disclosure, a “sponsor service” is a specific manner of the “value collection service”, and “sponsoring the sponsor service” or “sponsoring” or a “sponsor operation” or a similar concept in the following description of the present disclosure is a specific manner of “responding to the value collection service”.

Initiating the sponsor service is that a user raises money from at least one another user, so as to use the raised money to support a behaviour of the user, for example, purchase a commodity. Performing the sponsor service is sponsoring money for a user who initiates the sponsor service, so that the user who initiates the sponsor service may use the sponsored money to perform a behaviour. The behaviour may be purchasing a commodity, and the like. The amount of money that a user who performs the sponsor service sponsors may be a part of or all of the amount of sponsored money that the user who initiates the sponsor service needs to obtain.

An inventor finds that an existing sponsor service does not bring benefits or favors to a user who sponsors the sponsor service, resulting in an insufficient inner driving force for enabling the user to sponsor the sponsor service. Consequently, the efficiency of the sponsor service is low, and sufficient sponsored money cannot be ensured to obtain. To resolve the problem, the present disclosure may provide a sponsor service of a special type, that is, the sponsor service may bring favors to a user who sponsors the sponsor service.

Specifically, in the sponsor service provided in the present disclosure, the amount of sponsored money sponsored by the user may be converted by using a value conversion policy, and a user who initiates sponsoring is sponsored by using the amount of sponsored money obtained after the conversion. For example, the value conversion policy may be “1 RMB that is sponsored is equal to 2 RMB”, “1 RMB that is sponsored is equal to a 10 RMB voucher”, and the like. It should be noted that “the amount of sponsored money” described above is a specific representation form of the “transferred value” in the initiating the sponsor service and the performing the sponsor service in the present disclosure. A reader should understand that “the amount of sponsored money” and the “transferred value” are two different description manners of a same concept, but their essentials are the same. In the following description of the present disclosure, when “the amount of sponsored money” and the “transferred value” appear, details are not described again.

As described above, the service processing method provided in the present disclosure may be applicable to process the service for initiating sponsoring and the service for sponsoring. Step 501 to step 506 in this embodiment is a part in which the initiating the sponsor service is processed.

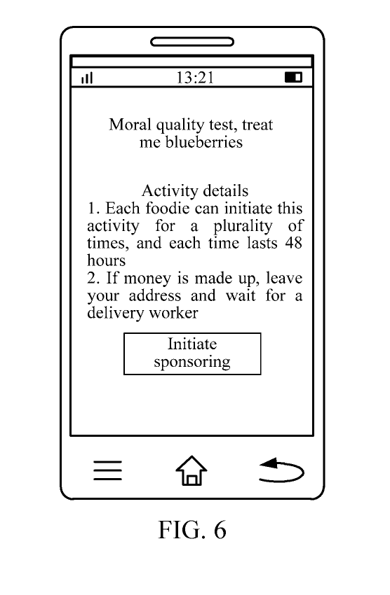

Specifically, the server may generate, according to settings of a skilled person or a merchant, an interface for describing a sponsored target, and send the interface for describing the sponsored target to the first terminal. As shown in FIG. 6, the interface for describing the sponsored target to the first terminal may be used to describe details of the target object to a user of the first terminal, that is, the first user, and may provide an initiating option for a sponsor service of the target object, that is, the initiating option of the value collection service described above. The target object may be a commodity such as a fruit or a digital product, or may be an activity such as dining together or travelling. The target object is not limited in the present disclosure. If the first user becomes interested in the target object by browsing the interface for describing the sponsored target object, the first user may trigger the initiating option, so as to initiate the sponsor service of the target object. Certainly, the initiating option may alternatively not be set on the interface for describing the sponsored target object, but is set on a page for purchasing the target object. After the first user becomes interested in the target object, the first user may select to purchase the target object or may select to trigger the initiating option to initiate the sponsor service of the target object, so that the first user may use money sponsored by using the sponsor service to purchase the target object. Certainly, the first terminal may alternatively set the initiating option to be at another location. A display location and a set location of the initiating option are not specifically limited in the present disclosure.

502: The first terminal sends, to the server according to an operation of the first user on the initiating option, a request for initiating value collection, the request for initiating value collection carrying an identifier of the target object and an identifier of the first user and the relationship type between the first user and the second user.

As described above, after the first user becomes interested in the target object, the first user may trigger the initiating option, so as to initiate the sponsor service of the target object. Step 502 to step 506 is a specific technical process in which the first terminal and the server initiates the sponsor service of the target object after the first user triggers the initiating option. In the following description of the present disclosure, a technical process of step 502 is described.

As described above, the sponsor service provided in the present disclosure is a special sponsor service, that is, in the sponsor service, the amount of sponsored money sponsored by a user is converted by using a value conversion policy, and the amount of sponsored money obtained after the conversion is used to sponsor a user who initiates the sponsor service.

In an embodiment of the present disclosure, the present disclosure may provide only a sponsor service of a sponsor type. The sponsor type is the value collection type described above. The sponsor type corresponds to a preset value conversion policy. In this case, after detecting a triggering operation of the first user for the initiating option, the first terminal may send a request for initiating sponsoring to the server. The request for initiating sponsoring is the request for initiating value collection described above. The request for initiating sponsoring may carry the identifier of the first user and the identifier of the target object, so that the server can initiate the sponsor service of the target object according to the request for initiating sponsoring. The sponsor service is a sponsor service of the foregoing sponsor type provided in the present disclosure. The identifier of the first user is used to uniquely determine the first user, and the identifier of the target object is used to uniquely determine the target object.

In another embodiment of the present disclosure, the present disclosure may provide sponsor services of various sponsor types. Different sponsor types correspond to different value conversion policies. In this case, before triggering the initiating option, or when triggering the initiating option, or after triggering the initiating option, the first user may select a sponsor type of a to-be-initiated sponsor service. The first terminal may obtain an identifier of the sponsor type according to the selection operation of the first user, and adds the identifier of the sponsor type to the request for initiating sponsoring sent to the server, so that the server may initiate the sponsor service of the target object according to the identifier of the sponsor type. The identifier of the sponsor type is used to uniquely determine a sponsor type.

It should be noted that the foregoing “sponsor type”, “request for initiating sponsoring”, and “identifier of the sponsor type” are specific representation forms of the “value collection type”, “request for initiating value collection”, and “value collection type identifier” in the initiating the sponsor service and the performing the sponsor service in the present disclosure. A reader should understand that the “sponsor type”, “request for initiating sponsoring”, and “identifier of the sponsor type”; and the “value collection type”, “request for initiating value collection”, and “value collection type identifier” are two different description manners corresponding to a same concept, but their essentials are the same. In the following description of the present disclosure, when the “sponsor type”, “request for initiating sponsoring”, and “identifier of the sponsor type”; and the “value collection type”, “request for initiating value collection”, and “value collection type identifier” appear, details are not further described again.

503: The server receives the request for initiating value collection sent by the first terminal.

504: The server obtains at least one target user from a user database according to the identifier of the first user, the at least one target user being a user on a user relationship chain of the first user.

As described above, the present disclosure provides a sponsor service that can bring benefits or favors to a user who sponsors the sponsor service. According to the sponsor service provided in the present disclosure, an inner driving force for enabling the user to sponsor the sponsor service can be increased, the efficiency of the sponsor service can be improved, and the sponsor service can be ensured to obtain sufficient sponsored money. To further improve the inner driving force for enabling the user to sponsor the sponsor service and improve the efficiency of the sponsor service, the present disclosure further provides the following technical solution.

In brief, the technical solution is: A sponsor service initiated by a user is sent to a terminal in which a user on a relationship chain of the user is located, so that the user who initiates the sponsor service has a personal relationship with the potential user who may sponsor the sponsor service, thereby further improving the inner driving force for enabling the user to sponsor, and improving the efficiency of the sponsor service.

Specifically, after receiving the request for initiating sponsoring sent by the first terminal, the server may extract the identifier of the first user and the identifier of the target object from the request for initiating sponsoring, and query the user database by using the identifier of the first user as an index, to obtain the at least one target user from the user database. The at least one target user is a user on the user relationship chain of the first user. Specifically, the server may obtain only a target user who has a strong relationship chain with the first user. The strong relationship chain refers to an acquaintance relationship chain, that is, the first user has a social relationship in the real world with the user on the strong relationship chain. For example, the first user and the target user follow each other, are friends with each other, and the like. The server may further obtain a target user on a weak relationship chain of the first user. The weak relationship chain refers to a stranger relationship chain, that is, the first user has no social relationship in the real world with the user on the weak relationship chain. For example, the first user and the target user have a common friend, the target user follows the first user in one way, and the like. Certainly, the server may further obtain the at least one target user according to selection of the first user. In this case, the first terminal may further add an identifier of the at least target user to the request for initiating sponsoring when sending the request for initiating sponsoring to the server. After receiving the request for initiating sponsoring, the server may extract the identifier of the at least one target user from the request for initiating sponsoring, to obtain the at least one target user. The at least one target user is not specifically limited in the present disclosure, and a manner of obtaining the at least one target user by the server is also not limited.

It should be noted that the target user includes, but is not limited to, a user who has a friend relationship, a following relationship, and/or a group relationship with the first user.

Certainly, in the present disclosure, content of step 504 may alternatively be not performed. In this case, in the present disclosure, the sponsor service initiated by the first user may be sent to any terminal that may sponsor the sponsor service of the first user. Specifically, the first user may log in to a dedicated sponsoring website, and initiate the sponsor service in a manner of publishing a post or information on the sponsoring website. After browsing the post or information published by the user, another user on the sponsoring website sponsors, according to personal preferences, the user who initiates the sponsor service. Because the sponsor service provided in the present disclosure is a special sponsor service that can bring benefits or favors to a user who sponsors the sponsor service, there is high probability that a user has no social relationship with the first user may sponsor the sponsor service initiated by the first user, thereby improving the efficiency of the sponsor service.

505: The server generates a value collection message according to the identifier of the target object and the identifier of the first user, the value collection message being used to provide an entry for responding to the value collection service.

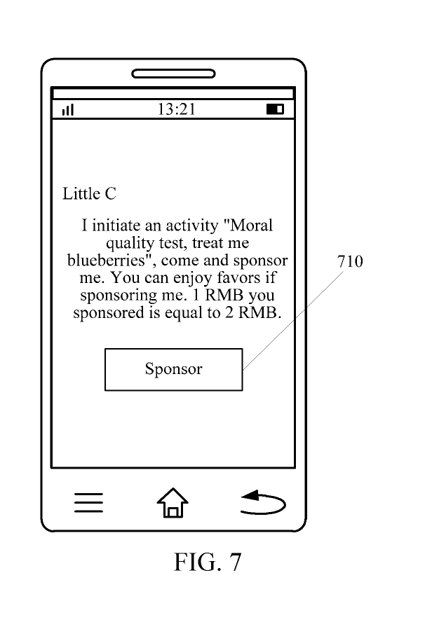

As described above, after receiving the request for initiating sponsoring sent by the first terminal, the server may extract the identifier of the first user and the identifier of the target object from the request for initiating sponsoring, so that the server may generate a sponsoring page according to the identifier of the target object and the identifier of the first user, that is, the value collection message described above. FIG. 7 shows the sponsoring page. The sponsoring page may include the identifier of the first user, for example, “little C”; and may further include content corresponding to the identifier of the target object, for example, “Moral quality test, treat me blueberries”, and the like. The sponsoring page may further provide an entry for responding to the sponsor service, that is, the entry for responding to the value collection service. The entry may be an option for sponsoring shown in 710 in FIG. 7. Certainly, the sponsoring page shown in FIG. 7 is merely exemplary, and is not intended to limit the present disclosure. In an actual application, there may be another specific representation form of the sponsoring page, and all representation forms of the sponsoring page within the spirit scope of the present disclosure shall fall within the protection scope of the present disclosure.

As described above, the request for initiating sponsoring sent by the first terminal to the server may further carry the identifier of the sponsor type. In this case, the server may further generate the sponsoring page according to the identifier of the target object, the identifier of the first user, and the identifier of the sponsor type. Specifically, as shown in FIG. 7, the sponsoring page may further include content corresponding to the identifier of the sponsor type, for example, “1 RMB that is sponsored is equal to 2 RMB”. In this case, an entry for sponsoring the target object provided on the sponsoring page is an entry corresponding to the identifier of the sponsor type, that is, a sponsor user may perform, by using the entry, a sponsor service satisfying the sponsor type.

It should be noted that the foregoing “sponsoring page” is a specific representation form of the “value collection message” in the initiating the sponsor service and the performing the sponsor service in the present disclosure. A reader should understand that the “sponsoring page” and the “value collection message” are two different description manners of a same concept, but their essentials are the same. In the following description of the present disclosure, when the “sponsoring page” and the “value collection message” appear, details are not further described again.

506: The server sends the value collection message to a client in which the at least one target user is located.

The server may send the sponsoring page generated in step 505 to the client in which the at least one target user obtained in step 504 is located. Specifically, the server may perform the foregoing sending operation when the at least one target user opens the client, or the server may perform the foregoing sending operation when the at least one target user is granted to receive sponsoring information. Timing for performing step 506 is not specifically limited in the present disclosure.

As described above, in the present disclosure, the technical process of step 504 may not be performed. Correspondingly, in step 506, the server may send the sponsoring page to any terminal that may sponsor the sponsor service initiated by the first user. For example, the server may send the sponsoring page to any terminal that browses the post or information published by the first user.

507: The second terminal receives and displays the value collection message of the first user, the second terminal being a terminal corresponding to the client in which any target user is located.

As described above, the service processing method provided in the present disclosure may be applicable to process the service for initiating sponsoring and the service for sponsoring. Step 501 to step 506 in this embodiment is the part in which the initiating the sponsor service is processed. Step 507 to step 511 in this embodiment is a part in which the performing the sponsor service is processed.

In step 507, the second terminal receives the sponsoring page of the first user sent by the server. The second terminal is a terminal corresponding to any client in which the target user is located in step 506. Specifically, the second terminal may send a sponsoring page obtaining request to the server after detecting a triggering operation for a specified connection, and receive the sponsoring page sent by the server. Certainly, the second terminal may alternatively send a sponsoring page obtaining request to the server after detecting a triggering operation for a specified option, and receive the sponsoring page sent by the server. A manner of receiving the sponsoring page by the second terminal is not limited in the present disclosure. After receiving the sponsoring page, the second terminal may display the sponsoring page. A second user is a user corresponding to the second terminal, that is, the target user.

As described above, the server may send the sponsoring page to any terminal that may sponsor the sponsor service initiated by the first user. In this case, the foregoing second terminal may alternatively be any terminal that may sponsor the sponsor service initiated by the first user. For example, the second terminal may be a terminal in which a user of the foregoing dedicated sponsoring website is located, that is, when logging in to the sponsoring website by using the terminal, the user of the sponsoring website may receive the value collection message of the first user in a manner such as viewing a web page or refreshing. Certainly, the sponsoring website may further provide a client, and the second terminal may be a terminal installed with the client of the sponsoring website.

508: The second terminal sends a value transfer request to the server according to an operation of a second user on the value collection message, the value transfer request carrying an identifier of the second user, the identifier of the first user, the identifier of the target object, and a transferred value.

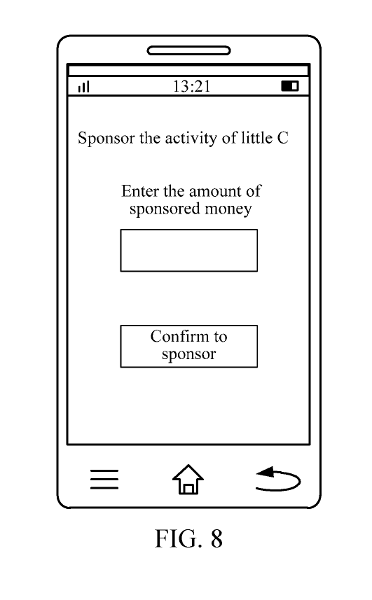

As described above, the sponsoring page may provide the entry for responding to the sponsor service. As shown in FIG. 7, the entry for responding to the sponsor service may be an option for sponsoring. In this case, when the second user wants to sponsor the sponsor service initiated by the first user, the second user may trigger the option for sponsoring, and the second terminal displays an interface for confirming sponsoring shown in FIG. 8 after detecting the triggering operation for the option for sponsoring. The interface for confirming sponsoring may include an area for inputting the amount of sponsored money, and the area for inputting the amount of sponsored money is used to receive a transferred value input by the second user. It should be noted that the transferred value may be a real currency value such as a Renminbi value or a US dollar value, or the transferred value may be a virtual currency value such as a bonus point value or a voucher value. The interface for confirming sponsoring may further include an option for confirming sponsoring. After detecting a triggering operation for the option for confirming sponsoring, the second terminal obtains the transferred value input by the second user in the area for inputting the amount of sponsored money, and sends a sponsoring request, that is, the value transfer request in the foregoing description of the present disclosure, to the server. The sponsoring request carries the identifier of the second user, the identifier of the first user, the identifier of the target object, and the transferred value.

To display more intuitively and avoid complex operations caused by interface switching, in an embodiment of the present disclosure, the foregoing sponsoring interface may provide the area for inputting the amount of sponsored money. In this case, after detecting an option for sponsoring of the second user on the sponsoring page, the second terminal obtains a transferred value input by the second user in the area for inputting the amount of sponsored money, and sends a sponsoring request to the server.

In an actual application, a skilled person, that is, an administrative user may set a plurality of fixed transferred values, to alleviate computing pressure of the server, and set a small transferred value to enable a user to be more inclined to perform a sponsoring operation. Therefore, in another embodiment of the present disclosure, the second terminal may provide an option for selecting a transferred value in the foregoing sponsoring page or the foregoing interface for confirming sponsoring. The second user may trigger the option for selecting a transferred value, to select any preset transferred value. In this case, after detecting a triggering operation for the option for sponsoring or the option for confirming sponsoring, the second terminal may obtain the transferred value selected by the second user, and sends a sponsoring request to the server.

Certainly, in an actual application, a skilled person, that is, an administrative user may alternatively set only one fixed transferred value. In this case, in another embodiment of the present disclosure, the second user may directly trigger the option for sponsoring. After detecting the triggering operation for the option for sponsoring, the second terminal may send a sponsoring request to the server and add the preset transferred value to the sponsoring request. The preset transferred value may be set by a skilled person or may be preset by the second user. This is not specifically limited in the present disclosure.

It should be noted that the foregoing “sponsoring request” is a specific representation form of the “value transfer request” in the initiating the sponsor service and the performing the sponsor service in the present disclosure. A reader should understand that the “sponsoring request” and the “value transfer request” are two different description manners of a same concept, but their essentials are the same. In the following description of the present disclosure, when the “sponsoring request” and the “value transfer request” appear, details are not further described again.

509: The server receives the value transfer request, the value transfer request carrying the identifier of the second user, the identifier of the first user, the identifier of the target object, and the transferred value.

510: The server converts the transferred value according to a value conversion policy, to obtain a final transferred value, and responds, based on the final transferred value, to the value collection service initiated by the first user.

As described above, the present disclosure may provide a sponsor service of only one sponsor type. In this case, the server may directly convert the transferred value by using a value conversion policy corresponding to the sponsor type, and sponsor, based on a converted transferred value, the sponsor service initiated by the first user.

Specifically, after receiving the sponsoring request, the server extracts the transferred value, the identifier of the second user, the identifier of the first user, and the identifier of the target object from the sponsoring request, and then the server converts the transferred value according to the value conversion policy corresponding to the sponsor type, to obtain the final transferred value. The final transferred value is a preset multiple of the transferred value. For example, if the transferred value is 10, the transferred value is multiplied by 2 by using the value conversion policy, so that after the transferred value is converted according to the value conversion policy, the final transferred value obtained by the server is 20.

As described above, the present disclosure may alternatively provide sponsor services of various sponsor types, that is, the server may initiate sponsor services of different sponsor types according to identifiers of the sponsor types carried in the request for initiating sponsoring sent by the first terminal, so that when the second user sponsors the sponsor services of different sponsor types, the server may performs the sponsor services according to the different sponsor types, that is, the server needs to convert, according to value conversion policies corresponding to the different the sponsor types, the transferred value carried in the sponsoring request sent by the second terminal, and sponsors, based on converted transferred values, the sponsor services initiated by the first user. In this case, the sponsoring request may further carry the identifier of the sponsor type, and the identifier of the sponsor type is used to uniquely identify a sponsor type.

Specifically, after receiving the sponsoring request, the server extracts the transferred value, the identifier of the second user, the identifier of the first user, the identifier of the target object, and the identifier of the sponsor type from the sponsoring request, and then the server converts, according to a value conversion policy corresponding to the identifier of the sponsor type, the transferred value, to obtain a final transferred value.

Different situations of obtaining the final transferred value are described in the foregoing description of the present disclosure. In the following description of the present disclosure, a specific process of responding to the value collection service, that is, the sponsor service based on the final transferred value is described.

In a first case, when the first user wants to purchase the target object, the responding, based on the final transferred value, to the value collection service, that is, the sponsor service includes: receiving, by the server, a target object purchase request sent by a client in which the first user is located; obtaining, by the server, a first difference between a target value and the final transferred value after receiving the target object purchase request, the target value being a value required for purchasing the target object; and subtracting, by the server, the first difference from an account bond with the first user, and adding the first difference and the transferred value to an account bond with the target object, to complete the behaviour of the first user for purchasing the target object; or subtracting, by the server, the first difference from an account bond with the first user, subtracting a second difference between the final transferred value and the transferred value from a specified account, and adding the first difference and the final transferred value to an account bond with the target object, to complete the behaviour of the first user for purchasing the target object.

For the sponsor service, after receiving the target object purchase request sent by the client in which the first user is located, the server obtains the first difference between the target value of the sponsor service initiated by the first user and the final transferred value. If the first difference is 0, that is, if the currently obtained amount of sponsored money has reached the target value of the sponsor service initiated by the first user, the first user may pay for the target object by using the sponsored money. Specifically, the server provides a payment option to the first terminal. After detecting a triggering operation for the payment option, the first terminal sends a payment request to the server. After receiving the payment request, the server pays for the target object by using the sponsored money, that is, adds the transferred value to the account bond with the target object. If the currently obtained amount of sponsored money does not reach the target value of the sponsor service initiated by the first user, that is, the first difference is not 0, the first user may make up the money difference, and pay for the target object by using the sponsored money and the money made up by the first user. Specifically, if the server detects that the currently obtained amount of sponsored money does not reach the target value of the sponsor service initiated by the first user, the server may provide an option for making up a difference value and purchasing to the first terminal. After detecting a triggering operation for the option for making up a difference value and purchasing, the first terminal sends a request for making up a difference value and purchasing to the server. After receiving the request for making up a difference value and purchasing, the server subtracts the first difference from the account bond with the first user, and pays for the target object by using the sponsored money and the money made up by the first user, that is, subtracts the first difference from the account bond with the first user, and adds the first difference and the transferred value to the account bond with the target object. Certainly, to enable a merchant who sells the target object to obtain sufficient profits, so as to improve motivation of participation of the merchant, the system may further subsidize the merchant, that is, the server subtracts a second difference between the final transferred value and the transferred value from a specified account, and adds the first difference and the final transferred value to an account bond with the target object, that is, the first user and the second user may obtain favors from the value conversion policy, and the system may subsidize the merchant, to enable the merchant to obtain sufficient profits.

In a second case, when the first user wants to give up purchasing the target object, the responding, based on the final transferred value, to the value collection service, that is, the sponsor service includes: returning the transferred value to an account bond with the second user or adding the transferred value to an account bond with the first user if the server receives a purchase giving up request sent by a client in which the first user is located.

For the sponsor service, when the currently obtained amount of sponsored money does not reach the target value of the sponsor service initiated by the first user, the first user may give up a payment operation for the target object. In this case, the server may return the currently obtained sponsored money to a corresponding sponsored user; or the server may add a value corresponding to the currently obtained sponsored money to the account bond with the first user. This is not limited in the present disclosure.

In an embodiment of the present disclosure, after performing the sponsoring operation in step 510, the server may further store the identifier of the target object, the identifier of the first user, the identifier of the second user, and the corresponding transferred value in a sponsored user database, so that the server may query the identifier of the second user and the corresponding transferred value from the sponsored user database in respond to a query request of the first user, the second user, or another user has corresponding permission.

In an embodiment of the present disclosure, after performing the sponsoring operation in step 510, the server may further send the identifier of the second user and the corresponding transferred value to the first terminal, so that the first user can learn, in real time, a status in which the second user sponsors the sponsor service initiated by the first user.

In an embodiment of the present disclosure, after performing the sponsoring operation in step 510, the server may further compute the difference between the target value of the sponsor service initiated by the first user and the currently obtained transferred value, and push the difference to a sponsoring page of the client in which the at least one target user is located, so that another user of a terminal that receives the sponsoring page may learn a sponsored status of the sponsor service initiated by the first user.

In an embodiment of the present disclosure, after the server performs the sponsoring operation in step 510 and computes the difference between the target value of the sponsor service initiated by the first user and the currently obtained transferred value, if the difference is equal to 0, it indicates that the sponsor service initiated by the first user has obtained sufficient sponsored money. In this case, the server may push sponsoring completed information to the client in which the at least one target user is located and the first terminal, so that the at least one target user and the first user learn that the sponsor service initiated by the first user is completed, and the server stops performing the sponsoring operation for the sponsor service initiated by the first user.

511: The server issues, to the second terminal, a token for initiating value collection, the token for initiating value collection including: a token for forwarding the value collection message initiated by the first user, or at least one of tokens for initiating another value collection service by the second terminal.

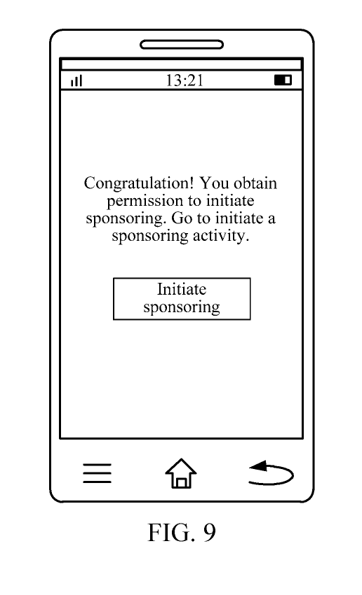

To reward a user who performs the sponsor service, so as to increase the inner driving force for enabling the user to perform the sponsor service and increase a rate of responding to the sponsor service of the user, the server may further issue a token for initiating sponsoring, that is, the token for initiating value collection described above, to the user who performs sponsoring, that is, the second user. The token for initiating sponsoring includes: a token for forwarding the sponsoring page initiated by the first user, or at least one of tokens for initiating another sponsoring service by the second terminal. The second terminal may receive the token for initiating sponsoring issued by the server. Specifically, the server may send, to the second terminal, a page for initiating sponsoring. As shown in FIG. 9, the page for initiating sponsoring may include an option for initiating sponsoring. After the second user triggers the option for initiating sponsoring, the server may perform the technical process from step 502 to step 506 again, so that the second user initiates another sponsor service. Alternatively, the server may provide, to the second terminal, an option for forwarding sponsoring. After the second terminal detects a triggering operation for the option for forwarding sponsoring, the second terminal may send, to the server, a request for forwarding sponsoring. The request for forwarding sponsoring carries the identifier of the second user and an identifier the sponsoring page. The server forwards, according to the identifier of the second user and the identifier of the sponsoring page, the sponsoring page of the first user to a client in which at least one user on a user relationship chain of the second user is located.

It should be noted that the foregoing “token for initiating sponsoring” is a specific representation form of the “token for initiating value collection” in the initiating the sponsor service and the performing the sponsor service in the present disclosure. A reader should understand that the “token for initiating sponsoring” and the “token for initiating value collection” are two different description manners of a same concept, but their essentials are the same. In the following description of the present disclosure, when the “token for initiating value collection” appear, details are not further described again.

It should be additionally noted that the foregoing “token” refers to a token in a service processing process. When a service processing request carries a token, it indicates that a requester has the token, so that the service processing request can be responded to. Certainly, when the token is received, authentication may further be performed on the token, so as to determine that the requester sending the token actually has the token. After the authentication succeeds, the service processing request is responded to. A specific process of authenticating the token is not limited in this embodiment of the present disclosure. The token may be considered as access permission on a function. Therefore, if the requester has the token, it indicates that the requester has obtained access permission, so that the requester can perform access and a subsequent function.

In an actual application, the sponsor service initiated by the first user always has a time limitation. After a preset time reaches, the sponsor service is disabled, that is, the second user cannot sponsor the sponsor service initiated by the first user. Therefore, in an embodiment of the present disclosure, after the preset time reaches, the server may send information indicating that the time for sponsoring is used up to the first terminal and the terminal associated with the at least one target user, and stops performing the sponsoring operation for the sponsor service initiated by the first user. The preset time is set by a skilled person and is not specifically limited in the present disclosure.

In an actual application, the first user may want to learn a completion status of the sponsor service initiated by the first user. To satisfy the requirement of the first user, in an embodiment of the present disclosure, the server may further obtain a value collection completion status of the target object; generate a value collection status interface according to the value collection completion status; and send the value collection status interface to the first terminal. The first terminal may receive and display the value collection status interface.

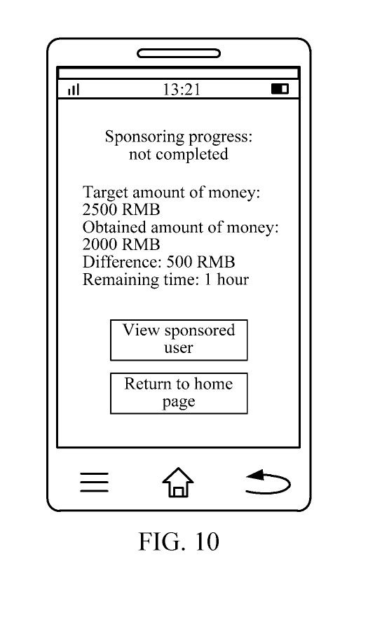

Specifically, in the sponsor service, the value collection completion status may include at least one of the currently obtained transferred value, that is, the amount of sponsored money, the difference between the target value of the sponsor service initiated by the first user and the currently obtained transferred value, and a remaining time of the sponsor service the target value. The server may generate the value collection status interface according to the value collection completion status, as shown in FIG. 10, and sends the value collection status interface to the first terminal.

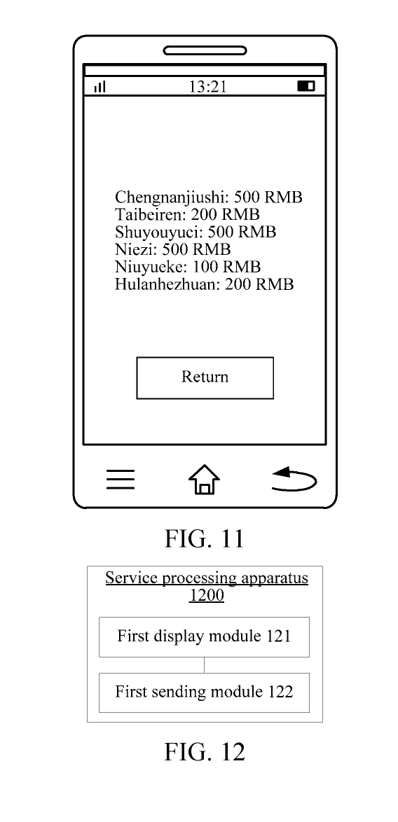

In an actual application, the first user may want to learn a user who sponsors the sponsor service initiated by the first user, to satisfy the requirement of the first user, in another embodiment of the present disclosure, the sponsoring status interface further includes an option for viewing a user who responds to value transfer. After detecting a triggering operation for the option for viewing a user who responds to value transfer, the first terminal obtains an identifier of a user who responds to the value collection service of the target object and a corresponding transferred value, and displays, based on the value collection status interface, the identifier of the user who responds to the value collection service of the target object and the corresponding transferred value, as shown in FIG. 11.

Specifically, in the sponsor service, the identifier of the user who responds to the value collection service of the target object and the corresponding transferred value may be sent by the server to the first terminal together with the value collection status interface. In this case, after detecting the triggering operation for the option for viewing a user who responds to value transfer, the first terminal may directly obtain the identifier of the user who responds to the value collection service of the target object and the corresponding transferred value locally. Certainly, the identifier of the user who responds to the value collection service of the target object and the corresponding transferred value may not be locally stored in the first terminal. In this case, after detecting the triggering operation for the option for viewing a user who responds to value transfer, the first terminal may send a request for obtaining a user who responds to value transfer. The request for obtaining a user who responds to value transfer carries the identifier of the first user and the identifier of the target object, so that the server queries the identifier of the user who responds to the value collection service of the target object and the corresponding transferred value from the foregoing database of a user who responds to value transfer, and returns a query result to the first terminal. After obtaining the identifier of the user who responds to the value collection service of the target object and the corresponding transferred value, the first terminal may display the identifier of the user who responds to the value collection service of the target object and the corresponding transferred value in a manner of covering or partially covering the sponsoring status interface. The foregoing display manner is not specifically limited in the present disclosure.

To sum up, according to the service processing method provided in this embodiment, the value collection message initiated by the first user is sent to the client in which the user on the relationship chain of the first user, that is, the client in which the second user is located, so that the second user can respond to the value collection service initiated by the first user. In addition, the transferred value of the second user is converted by using the value conversion policy, and the value collection service initiated by the first user is responded to by using the converted transferred value. Therefore, when the method is applied to the sponsor service, on one hand, because the user on the relationship chain of the first user, that is, the second user has a personal relationship with the first user, the probability that the second user sponsors the sponsor service initiated by the first user is relatively large, thereby improving the efficiency of the sponsor service, and ensuring that the sponsor service can obtain sufficient money. Therefore, adhesion of the user is increased. On the other hand, because a converted transferred value obtained by converting, by using the value conversion policy, a transferred value that the second user wants to provide is always greater than the transferred value that the second user wants to provide, so that the second user can sponsor the sponsor service of the first user with a relatively large value by using a relatively small transferred value. This can increase the inner driving force for enabling the second user to sponsor, so that the probability that the second user sponsors the sponsor service initiated by the first user is increased, thereby improving the efficiency of the sponsor service, and ensuring that the sponsor service can obtain sufficient money. Therefore, the adhesion of the user is increased.

Further, after the second user responds to the value collection service initiated by the first user, the second user may obtain the token for initiating value collection, that is, the second user may obtain the token for initiating another value collection, or the token for forwarding the value collection message initiated by the first user. When the method is applied to the sponsor service, the inner driving force for enabling the second user to sponsor can also be increased, so that the probability that the second user sponsors the sponsor service initiated by the first user is increased, thereby improving the efficiency of the sponsor service, and ensuring that the sponsor service can obtain sufficient money. Therefore, the adhesion of the user is increased.

FIG. 12 is a block diagram of a service processing apparatus 1200 according to an exemplary embodiment. As shown in FIG. 12, the service processing apparatus includes a first display module 121 and a first sending module 122.

The first display module 121 is configured to display a value collection message initiated by a first user, the value collection message being used to provide an entry for responding to a value collection service, and the value collection service being used by a user other than the first user to provide a value for a behaviour of the first user for purchasing a target object.

The first sending module 122 is configured to send a value transfer request to a server according to an operation of a second user on the value collection message displayed by the first display module 121, the value transfer request carrying an identifier of the second user, an identifier of the first user, an identifier of the target object, and a transferred value, so that the server converts the transferred value according to a value conversion policy and responds, based on a converted transferred value, to the value collection service initiated by the first user.

The value conversion policy includes: converting the transferred value into a final transferred value, the final transferred value being a preset multiple of the transferred value.

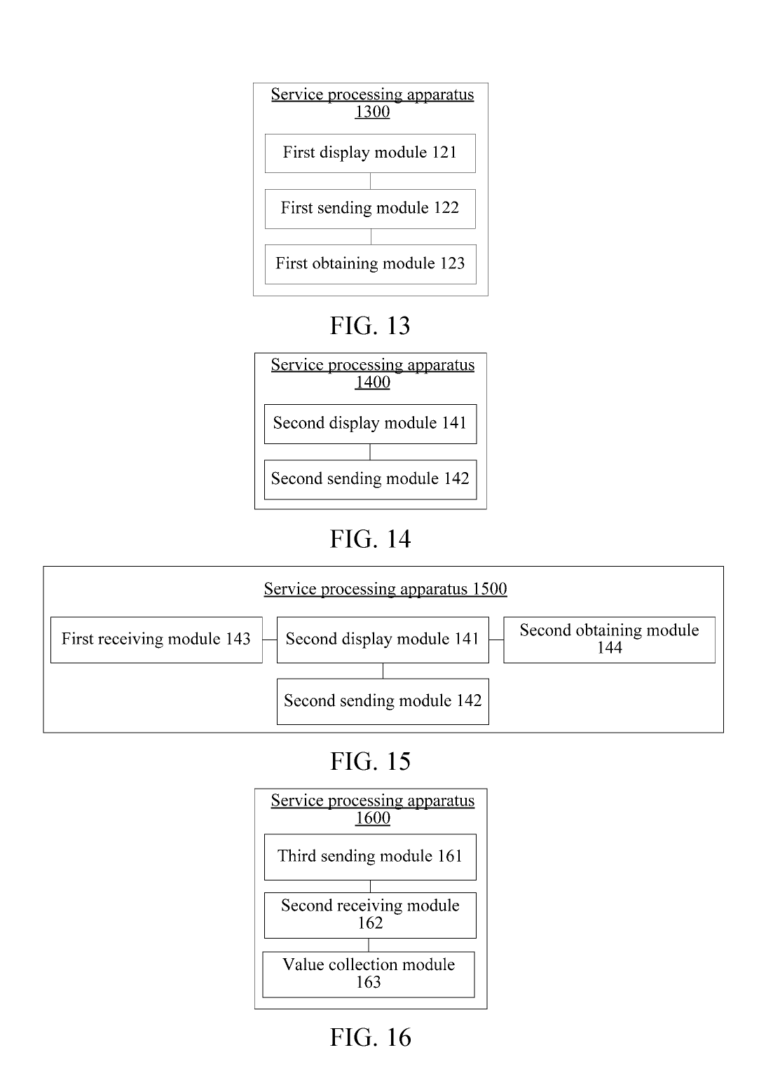

Referring to FIG. 13, in another embodiment of the present disclosure, another service processing apparatus 1300 is further provided. The apparatus is based on the foregoing embodiment structure in FIG. 12 and further includes a first obtaining module 123.

The obtaining module 123 is configured to obtain a token for initiating value collection, the token for initiating value collection being issued by the server after the server responds, based on the converted transferred value, to the value collection service initiated by the first user, and the token for initiating value collection including: a token for forwarding the value collection message initiated by the first user, or at least one of tokens for initiating another value collection service by the tokens themselves.

To sum up, according to the service processing apparatus provided in this embodiment, the value collection message initiated by the first user is displayed, the value transfer request is sent to the server according to the operation of the second user on the value collection message, and the transferred value of the second user is converted according to the value conversion policy, so that the converted transferred value is used to respond to the value collection service initiated by the first user. Because the transferred value obtained by converting the transferred value of the second user by using the value conversion policy is always greater than the original transferred value of the second user, the second user may respond to the value collection service of the first user with a relatively large value by using a relatively small transferred value. When the method is applied to a sponsor service, an inner driving force for enabling the second user to sponsor can be increased, so that the probability that the second user sponsors the sponsor service initiated by the first user is increased, thereby improving the efficiency of the sponsor service, and ensuring that the sponsor service can obtain a sufficient transferred value. Therefore, adhesion of the user is increased.

FIG. 14 is a block diagram of a service processing apparatus 1400 according to an exemplary embodiment. As shown in FIG. 14, the service processing apparatus includes a second display module 141 and a second sending module 142.

The second display module 141 is configured to display an initiating option for a value collection service of a target object, the value collection service being used by a second user other than a first user to provide a value for a behaviour of the first user for purchasing the target object.

The second sending module 142 is configured to send, to a server according to an operation of the first user on the initiating option displayed by the second display module 141, a request for initiating value collection, the request for initiating value collection carrying an identifier of the target object and an identifier of the first user and the relationship type between the first user and the second user, so that the server generates a value collection message and sends the value collection message to a second terminal associated with the second user, the value collection message being used to provide an entry for responding to the value collection service, and the at least one target client being a client in which a user on a user relationship chain of the first user is located.

The request for initiating value collection further carries a value collection type identifier, the value collection type identifier is used to enable the server to generate a value collection message corresponding to the value collection type identifier, and different value collection type identifiers correspond to different value conversion policies.

Referring to FIG. 15, in another embodiment of the present disclosure, another service processing apparatus 1500 is further provided. The apparatus is based on the foregoing embodiment structure in FIG. 14 and further includes a first receiving module 143 and a second obtaining module 144.

The first receiving module 143 is configured to receive a value collection status interface, the value collection status interface being used to indicate a value collection completion status of the target object.

The second display module 141 is further configured to display the value collection status interface received by the first receiving module 143.

The value collection status interface further includes an option for viewing a user who responds to the value collection, and the second obtaining module 144 is configured to obtain an identifier of a user who responds to the value collection service of the target object and a corresponding transferred value, after a triggering operation for the option for viewing a user who responds to the value collection is detected.

The second display module 141 is further configured to display, based on the value collection status interface received by the first receiving module 143, the identifier of the user and the corresponding transferred value that are obtained by the second obtaining module 144.

To sum up, according to the service processing method provided in this embodiment, the request for initiating value collection is sent to the server, so that the server generates the value collection message, and sends the value collection message to the client in which the user on the relationship chain of the first user is located. Therefore, the user on the relationship chain of the first user can respond to the value collection service initiated by the first user. When the apparatus is applied to a sponsor service, because the user on the relationship chain of the first user has a personal relationship with the first user, the probability that the user on the relationship chain of the first user sponsors the sponsor service initiated by the first user is relatively large, thereby increasing the efficiency of the sponsor service, and ensuring that the sponsor service can obtain sufficient money. Therefore, adhesion of the user is increased.

FIG. 16 is a block diagram of a service processing apparatus 1600 according to an exemplary embodiment. As shown in FIG. 16, the service processing apparatus includes a third sending module 161, a second receiving module 162, and a value collection module 163.

The third sending module 161 is configured to send, to a client in which a second user is located, a value collection message initiated by a first user, so that the client in which the second user is located sends a value transfer request to itself according to an operation of the second user on the value collection message.

The receiving module 162 is configured to receive the value transfer request, the value transfer request carrying an identifier of the second user, an identifier of the first user, an identifier of a target object, and a transferred value.

The value collection module 163 is configured to convert the transferred value according to a value conversion policy, to obtain a final transferred value, and respond, based on the final transferred value, to a value collection service initiated by the first user, the value collection service being used by a user other than the first user to provide a value for a behaviour of the first user for purchasing the target object.

The value conversion policy includes: converting the transferred value into the final transferred value, the final transferred value being a preset multiple of the transferred value.

In an embodiment of the present disclosure, the value collection module 163 is configured to:

receive a target object purchase request sent by a client in which the first user is located;

obtain a first difference between a target value and the final transferred value after receiving the target object purchase request, the target value being a value required for purchasing the target object; and subtract the first difference from an account bond with the first user, and add the first difference and the transferred value to an account bond with the target object, to complete the behaviour of the first user for purchasing the target object; or subtract the first difference from an account bond with the first user, subtract a second difference between the final transferred value and the transferred value from a specified account, and add the first difference and the final transferred value to an account bond with the target object, to complete the behaviour of the first user for purchasing the target object.

In an embodiment of the present disclosure, the value collection module 163 is configured to:

return the transferred value to an account bond with the second user or add the transferred value to an account bond with the first user if receiving a purchase giving up request sent by a client in which the first user is located.

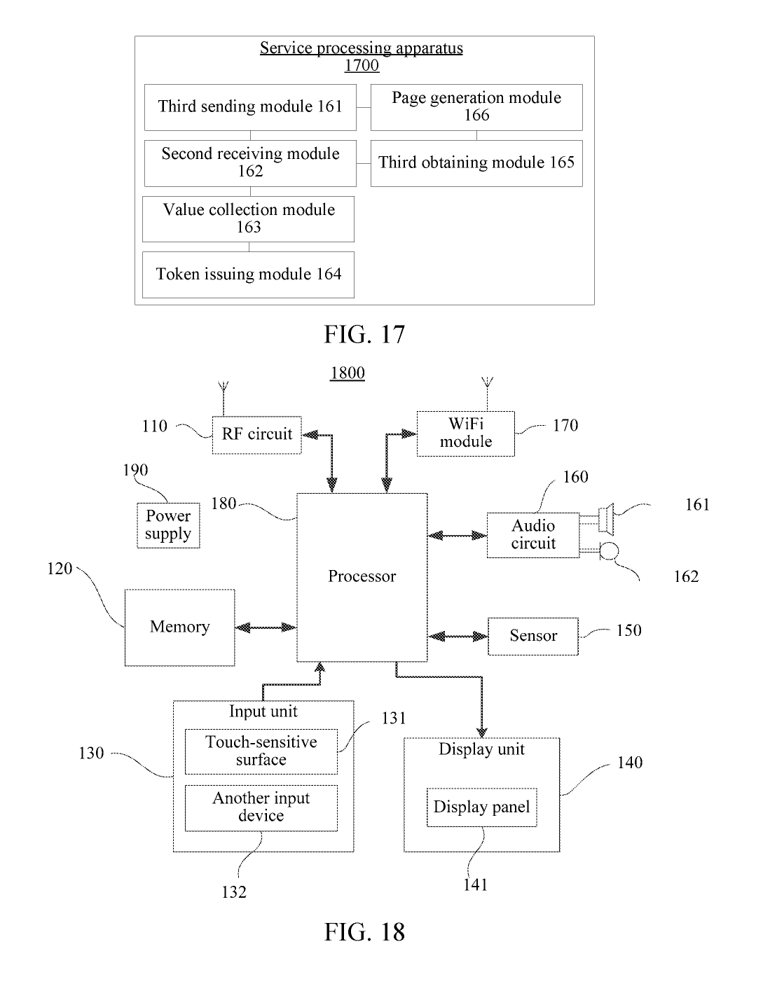

Referring to FIG. 17, in another embodiment of the present disclosure, another service processing apparatus 1700 is further provided. The apparatus is based on the foregoing embodiment structure in FIG. 16 and further includes a token issuing module 164, a third obtaining module 165, and a page generation module 166.

The token issuing module 164 is configured to issue, to the client in which the second user is located, a token for initiating value collection, the token for initiating value collection including: a token for forwarding the value collection message initiated by the first user, or at least one of tokens for initiating another value collection service by the client in which the second user is located.

The second receiving module 162 is further configured to receive a request for initiating value collection sent by the client in which the first user is located, the request for initiating value collection carrying the identifier of the target object and the identifier of the first user;

The third obtaining module 165 is configured to obtain at least one target user from a user database according to the identifier of the first user, the at least one target user being a user on a user relationship chain of the first user.

The page generation module 166 is configured to generate the value collection message according to the identifier of the target object and the identifier of the first user, the value collection message being used to provide an entry for responding to the value collection service.

The third sending module 161 is further configured to send the value collection message generated by the page generation module 166 to a client in which the at least one target user obtained by the third obtaining module 165 is located.

The third obtaining module 165 is further configured to obtain a value collection completion status of the target object.

The page generation module 166 is further configured to generate a value collection status interface according to the value collection completion status obtained by the third obtaining module 165.

The third sending module 161 is further configured to send the value collection status interface generated by the page generation module 166 to the client in which the first user is located.

The third obtaining module 165 is further configured to obtain an identifier of a user who responds to the value collection service of the target object and a corresponding transferred value.

The third sending module 161 is further configured to send the identifier of the user and the corresponding transferred value that are obtained by the third obtaining module 165 to the client in which the first user is located.

The request for initiating value collection further carries a value collection type identifier, and different value collection type identifiers correspond to different value conversion policies. The page generation module 166 is further configured to generate the value collection message according to the identifier of the target object, the identifier of the first user, and the value collection type identifier.

To sum up, according to the service processing apparatus provided in this embodiment, the value collection message initiated by the first user is sent to the client in which the second user is located, so that the second user can respond to the value collection service initiated by the first user. In addition, the transferred value of the second user is converted by using the value conversion policy, and the value collection service initiated by the first user is responded to by using the converted transferred value. Therefore, when the apparatus is applied to a sponsor service, on one hand, because the second user has a personal relationship with the first user, the probability that the second user sponsors the sponsor service initiated by the first user is relatively large, thereby improving the efficiency of the sponsor service, and ensuring that the sponsor service can obtain sufficient money. Therefore, adhesion of the user is increased. On the other hand, because a converted transferred value obtained by converting, by using the value conversion policy, a transferred value that the second user wants to provide is always greater than the transferred value that the second user wants to provide, so that the second user can sponsor the sponsor service of the first user with a relatively large value by using a relatively small transferred value. This can increase an inner driving force for enabling the second user to sponsor, so that the probability that the second user sponsors the sponsor service initiated by the first user is increased, thereby improving the efficiency of the sponsor service, and ensuring that the sponsor service can obtain sufficient money. Therefore, the adhesion of the user is increased.

It should be noted that, division of the foregoing functional modules are only described as an example when the service processing apparatus provided in the foregoing embodiments performs service processing. In an actual application, the foregoing functions may be allocated according to needs to be implemented by different functional modules, that is, the internal structure of the apparatus is divided into different functional modules to implement all or some of the foregoing described functions. In addition, the service processing apparatus provided in the foregoing embodiments and the service processing method in the foregoing embodiments are based on the same concept. For a specific implementation process, refer to the method embodiments, and details are not described herein again.

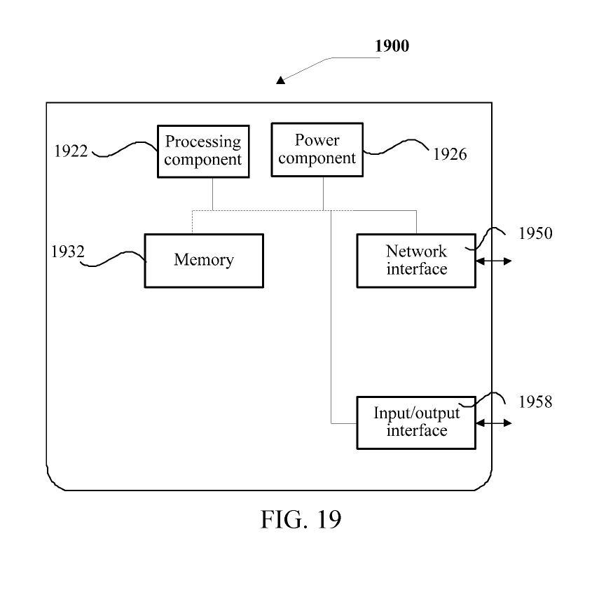

An embodiment provides a terminal. The terminal may be configured to perform the service processing method according to the foregoing embodiments. Referring to FIG. 18, the terminal 1800 includes:

The terminal 1800 may include components such as a radio frequency (RF) circuit 110, a memory 120 including one or more computer readable storage mediums, an input unit 130, a display unit 140, a sensor 150, an audio circuit 160, a Wireless Fidelity (WiFi) module 170, a processor 180 including one or more processing cores, and a power supply 190. A person skilled in the art may understand that the structure of the terminal shown in FIG. 18 does not constitute a limitation to the terminal, and the terminal may include more components or fewer components than those shown in the figure, or some components may be combined, or a different component deployment may be used.

The RF circuit 110 may be configured to receive and send signals during an information receiving and sending process or a call process. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), email, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1800, and the like. In addition, the memory 120 may include a high speed random access memory, and may further include a non-volatile memory, such as at least one magnetic disk storage device, a flash memory, or another volatile solid-state storage device.

Correspondingly, the memory 120 may further include a memory controller, so as to provide access of the processor 180 and the input unit 130 to the memory 120.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touchscreen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch signal from the touch detection apparatus, converts the touch signal into touch point coordinates, and sends the touch point coordinates to the processor 180. Moreover, the touch controller can receive and execute a command sent from the processor 180. In addition, the touch-sensitive surface 131 may be a resistive, capacitive, infrared, or surface sound wave type touch-sensitive surface. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user interfaces of the terminal 1800. The graphical user interfaces may be formed by a graph, a text, an icon, a video, or any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides corresponding visual output on the display panel 141 according to the type of the touch event. Although, in FIG. 18, the touch-sensitive surface 131 and the display panel 141 are used as two separate parts to implement input and output functions, in some embodiments, the touch-sensitive surface 131 and the display panel 141 may be integrated to implement the input and output functions.

The terminal 1800 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1800 is moved to the ear. As one type of motion sensor, a gravity acceleration sensor can detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal 1800, are not further described herein.

The audio circuit 160, a speaker 161, and a microphone 162 may provide audio interfaces between the user and the terminal 1800. The audio circuit 160 may convert received audio data into an electric signal and transmit the electric signal to the speaker 161. The speaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1800.

WiFi is a short distance wireless transmission technology. The terminal 1800 may help, by using the WiFi module 170, the user to receive and send emails, browse a web page, access streaming media, and so on, which provides wireless broadband Internet access for the user. Although FIG. 18 shows the WiFi module 170, it may be understood that the WiFi module is not a necessary component of the terminal 1800, and when required, the WiFi module may be omitted as long as the scope of the essence of the present disclosure is not changed.

The processor 180 is the control center of the terminal 1800, and is connected to various parts of the mobile phone by using various interfaces and lines. By running or executing a software program and/or module stored in the memory 120, and invoking data stored in the memory 120, the processor 180 performs various functions and data processing of the terminal 1800, thereby performing overall monitoring on the mobile phone. Optionally, the processor 180 may include one or more processor cores. Preferably, the processor 180 may integrate an application processor and a modem. The application processor mainly processes an operating system, a user interface, an application program, and the like. The modem mainly processes wireless communication. It may be understood that the foregoing modem may either not be integrated into the processor 180.

The terminal 1800 further includes the power supply 190 (such as a battery) for supplying power to the components. Preferably, the power supply may be logically connected to the processor 180 by using a power management system, thereby implementing functions such as charging, discharging and power consumption management by using the power management system. The power supply 190 may further include one or more of a direct current or alternating current power supply, a re-charging system, a power failure detection circuit, a power supply converter or inverter, a power supply state indicator, and any other components.

Although not shown in the figure, the terminal 1800 may further include a camera, a Bluetooth module, and the like, which are not further described herein. Specifically, in this embodiment, the display unit of the terminal is a touchscreen display. The terminal further includes a memory and one or more programs. The one or more programs are stored in the memory and configured to be executed by one or more processors. The one or more programs include instructions used for performing the following operations: displaying a value collection message initiated by a first user, the value collection message being used to provide an entry for responding to a value collection service, and the value collection service being used by a user other than the first user to provide a value for a behaviour of the first user for purchasing a target object; and sending a value transfer request to a server according to an operation of a second user on the value collection message, the value transfer request carrying an identifier of the second user, an identifier of the first user, an identifier of the target object, and a transferred value, so that the server converts the transferred value according to a value conversion policy and responds, based on a converted transferred value, to the value collection service initiated by the first user.

Alternatively, the one or more programs include instructions used for performing the following operations: displaying an initiating option for a value collection service of a target object, the value collection service being used by a second user other than a first user to provide a value for a behaviour of the first user for purchasing the target object; and sending, to a server according to an operation of the first user on the initiating option, a request for initiating value collection, the request for initiating value collection carrying an identifier of the target object and an identifier of the first user and the relationship type between the first user and the second user, so that the server generates a value collection message and sends the value collection message to a second terminal associated with the second user, the value collection message being used to provide an entry for responding to the value collection service, and the at least one target client being a client in which a user on a user relationship chain of the first user is located.

In an exemplary embodiment, a non-transitory computer readable storage medium including instructions is further provided, for example, a memory including instructions, and the foregoing instructions may be executed by a processor in the server to complete the service processing method that is on a side of the terminal in the foregoing embodiments. For example, the non-transitory computer readable storage medium may be a ROM, a random access memory (RAM), a CD-ROM, a magnetic tape, a floppy disk, or an optical data storage device.

FIG. 19 is a block diagram of a service processing apparatus 1900 according to an exemplary embodiment. For example, the apparatus 1900 may be provided as a server. Referring to FIG. 19, the apparatus 1900 includes a processing component 1922, and further includes one or more processors, and a memory resource represented by a memory 1932. The memory 1932 is configured to store instructions that can be executed by the processing component 1922, for example, an application program. The application program stored in the memory 1932 may include one or more modules, and each module corresponds to a group of instructions. In addition, the processing component 1922 is configured to execute instructions to perform the following method: sending, to a client in which a second user is located, a value collection message initiated by a first user, so that the client in which the second user is located sends a value transfer request to itself according to an operation of the second user on the value collection message; receiving the value transfer request, the value transfer request carrying an identifier of the second user, an identifier of a first user, an identifier of a target object, and a transferred value; and converting the transferred value according to a value conversion policy, to obtain a final transferred value, and respond, based on the final transferred value, to a value collection service initiated by the first user, the value collection service being used by a user other than the first user to provide a value for a behaviour of the first user for purchasing the target object.

The apparatus 1900 may further include a power component 1926 configured to perform power management of the apparatus 1900, a wired or wireless network interface 1950 configured to connect the apparatus 1900 to a network, and an input/output (I/O) interface 1958. The apparatus 1900 may operate an operating system, such as Windows Server″, Mac OS X™, Unix™, Linux™, or FreeBSD™, that is stored in the memory 1932.

In an exemplary embodiment, a non-transitory computer readable storage medium including instructions is further provided, for example, a memory including instructions, and the foregoing instructions may be executed by a processor in the server to complete the service processing method that is on a side of the server in the foregoing embodiments. For example, the non-transitory computer readable storage medium may be a ROM, a random access memory (RAM), a CD-ROM, a magnetic tape, a floppy disk, or an optical data storage device.

A person of ordinary skill in the art may understand that all or some of the steps of the foregoing embodiments may be implemented by using hardware, or may be implemented by using a program instructing relevant hardware. The program may be stored in a computer readable storage medium. The storage medium may be a read-only memory, a magnetic disk, an optical disc, or the like.

The foregoing descriptions are merely preferred embodiments of the present disclosure, but are not intended to limit the present disclosure. Any modification, equivalent replacement, or improvement made in accordance with the spirit and principle of the present disclosure should fall within the protection scope of the present disclosure.

What is claimed is:

1. A service processing method performed at a first terminal having one or more processors and memory storing instructions to be executed by the one or more processors, the method comprising:
displaying an initiating option user interface for a value collection service of a target object, the value collection service being used by a second user other than a first user to provide a value for a behaviour of the first user for purchasing the target object;
detecting, from the first user, a user response to the initiating option, the user response including a relationship type between the first user and the second user; and
sending, to a server, a request for initiating value collection, the request for initiating value collection carrying an identifier of the target object and an identifier of the first user and the relationship type between the first user and the second user and the relationship type between the first user and the second user, wherein the server is configured to generate a value collection message accordingly and sends the value collection message to a second terminal associated with the second user.

2. The method according to claim 1, wherein after the sending, to a server, a request for initiating value collection, the method further comprises:
receiving, from the server, an update message on the value collection, the update message including values that have been collected from each user account that has received the value collection message;
generating a value collection status interface based on the update message; and
displaying the value collection status interface.

3. The method according to claim 0, wherein the value collection status interface further comprises at least one option to check a current status of the values that have been collected from each user account that has received the value collection message, the method further comprises:
obtaining an identifier of a user who responds to the value collection service of the target object and a corresponding transferred value, after a triggering operation for the option for viewing a user who responds to the value collection is detected; and
displaying the identifier of the user and the corresponding transferred value based on the value collection status interface.

4. The method according to claim 1, wherein the request for initiating value collection further carries a value collection type identifier, the value collection type identifier is used to enable the server to generate a value collection message corresponding to the value collection type identifier, and different value collection type identifiers correspond to different value conversion policies.

5. The method according to claim 1, wherein the value collection message includes an indicator of the relationship type between the first user and the second user.

6. The method according to claim 5, wherein the indicator indicates that the first user is a direct-contact of the second user.

7. The method according to claim 5, wherein the indicator identifies one or more chat groups of the first user and the second user are members.

8. The method according to claim 5, wherein the indicator identifies one or more third-party official accounts of the first user and the second user are subscribers.

9. A first terminal comprising:
one or more processors;
memory; and
a plurality of instructions stored in the memory that, when executed by the one or more processors, cause the first terminal to perform the following operations:
displaying an initiating option user interface for a value collection service of a target object, the value collection service being used by a second user other than a first user to provide a value for a behaviour of the first user for purchasing the target object;
detecting, from the first user, a user response to the initiating option, the user response including a relationship type between the first user and the second user; and
sending, to a server, a request for initiating value collection, the request for initiating value collection carrying an identifier of the target object and an identifier of the first user and the relationship type between the first user and the second user and the relationship type between the first user and the second user, wherein the server is configured to generate a value collection message accordingly and sends the value collection message to a second terminal associated with the second user.

10. The first terminal according to claim 9, wherein the operations further comprises:
receiving, from the server, an update message on the value collection, the update message including values that have been collected from each user account that has received the value collection message;
generating a value collection status interface based on the update message; and
displaying the value collection status interface.

11. The first terminal according to claim 10, wherein the value collection status interface further comprises at least one option to check a current status of the values that have been collected from each user account that has received the value collection message, the operations further comprises:
obtaining an identifier of a user who responds to the value collection service of the target object and a corresponding transferred value, after a triggering operation for the option for viewing a user who responds to the value collection is detected; and
displaying the identifier of the user and the corresponding transferred value based on the value collection status interface.

12. The first terminal according to claim 9, wherein the request for initiating value collection further carries a value collection type identifier, the value collection type identifier is used to enable the server to generate a value collection message corresponding to the value collection type identifier, and different value collection type identifiers correspond to different value conversion policies.

13. The first terminal according to claim 9, wherein the value collection message includes an indicator of the relationship type between the first user and the second user.

14. The first terminal according to claim 13, wherein the indicator indicates that the first user is a direct-contact of the second user.

15. The first terminal according to claim 13, wherein the indicator identifies one or more chat groups of the first user and the second user are members.

16. The first terminal according to claim 13, wherein the indicator identifies one or more third-party official accounts of the first user and the second user are subscribers.

17. A non-transitory computer readable medium storing at least one program configured for execution by a first terminal having one or more processors, the at least one program comprising instructions for:
displaying an initiating option user interface for a value collection service of a target object, the value collection service being used by a second user other than a first user to provide a value for a behaviour of the first user for purchasing the target object;
detecting, from the first user, a user response to the initiating option, the user response including a relationship type between the first user and the second user; and
sending, to a server, a request for initiating value collection, the request for initiating value collection carrying an identifier of the target object and an identifier of the first user and the relationship type between the first user and the second user and the relationship type between the first user and the second user, wherein the server is configured to generate a value collection message accordingly and sends the value collection message to a second terminal associated with the second user.

18. The non-transitory computer readable medium according to claim 17, wherein after the sending, to a server, a request for initiating value collection, the instructions further comprise:
receiving, from the server, an update message on the value collection, the update message including values that have been collected from each user account that has received the value collection message;
generating a value collection status interface based on the update message; and
displaying the value collection status interface.

19. The non-transitory computer readable medium according to claim 18, wherein the value collection status interface further comprises at least one option to check a current status of the values that have been collected from each user account that has received the value collection message, the instructions further comprise:
obtaining an identifier of a user who responds to the value collection service of the target object and a corresponding transferred value, after a triggering operation for the option for viewing a user who responds to the value collection is detected; and
displaying the identifier of the user and the corresponding transferred value based on the value collection status interface.

20. The non-transitory computer readable medium according to claim 17, wherein the value collection message includes an indicator of the relationship type between the first user and the second user.
